(19) United States
(12) Patent Application Publication
(10) Pub. No.: US 2008/0162612 A1
(43) Pub. Date: Jul. 3, 2008

(54) Method for block relinking

(76) Inventors: Andrew Tomlin, San Jose, CA (US); Sergey Anatolievich Gorobets, Edinburgh (GB); Shai Traister, Sunnyvale, CA (US)

Correspondence Address: WEAVER AUSTIN VILLENEUVE SAMPSON LLP, ATTN: SANDISK, P.O. BOX 70250, OAKLAND, CA, 94612-0250, US

(21) Appl. No.: 11/648,487

(22) Filed: Dec. 28, 2006

(51) Int. Cl. G06F 12/02

(52) U.S. Cl. 707/206

(57) ABSTRACT

In accordance with various embodiments of the present invention, block relinking during garbage collection is described. Block relinking may include writing a memory write to update a block of a first metablock to a block of a second metablock, copying valid portions of the block of the first metablock to the block of the second metablock, and linking the block of the second metablock to the first metablock.

### CROSS-REFERENCES TO RELATED APPLICATIONS

This application is related to U.S. patent application Ser. No. ______ (Attorney Docket No. SAN-015), filed on Dec. 28, 2006, and entitled “System for Block Relinking;” is related to U.S. patent application Ser. No. 11/540,778 (Attorney Docket No. SAN-004), filed on Sep. 29, 2006, and entitled “Method for Phased Garbage Collection;” is related to U.S. patent application Ser. No. 11/541,371 (Attorney Docket No. SAN-014), filed on Sep. 29, 2006, and entitled “System for Phased Garbage Collection;” is related to U.S. patent application Ser. No. 11/541,035 (Attorney Docket No. SAN-005), filed on Sep. 28, 2006, and entitled “Methods for Phased Garbage Collection Using Phased Garbage Collection Block or Scratch Pad Block as a Buffer;” is related to U.S. patent application Ser. No. 11/541,012 (Attorney Docket No. SAN-013), filed on Sep. 28, 2006, and entitled “Memory Systems for Phased Garbage Collection Using Phased Garbage Collection Block or Scratch Pad Block as a Buffer;” is related to U.S. patent application Ser. No. 11/040,325 (Attorney Docket No. SNDK.434US0), filed on Jan. 20, 2005, and entitled “Scheduling of Housekeeping Operations in Flash Memory Systems;” is related to U.S. application Ser. No. 11/499,606 (Attorney Docket No. SAN-007), filed on Aug. 4, 2006, and entitled “Methods for Phased Garbage Collection;” and is related to U.S. patent application Ser. No. 11/499,598 (Attorney Docket No. SAN-008), filed on Aug. 4, 2006, and entitled “Non-Volatile Memory Storage Systems for Phased Garbage Collection,” the disclosures of which are incorporated herein by reference.

### FIELD OF THE INVENTION

The present invention relates generally to memory operations and, more particularly, to methods and systems for performing block relinking.

### BACKGROUND

In non-volatile memory systems, blocks of data stored in the memory are periodically garbage collected (i.e., compacted or consolidated) to reclaim a memory's storage capacity. In a typical garbage collection operation, valid data from a block are copied to another block. After the valid data are transferred, the original metablock is erased to provide storage capacity. Currently, a write operation can trigger a memory system to perform a garbage collection operation. The host allows a fixed amount of time for the execution of the write operation and the garbage collection operation. For example, the Secure Digital protocol limits the amount of time to 250 milliseconds. A timeout error can result if the memory system exceeds this fixed amount of time in a write operation.

The sizes of memory blocks have been increasing due to increased capacity, higher parallelism, and die size scaling. Accordingly, execution of write operations and the performance of garbage collection operations are taking longer because more data are transferred. A garbage collection operation can therefore easily exceed the fixed amount of time allocated to the write operation. As a result, there is a need to prevent the timeout errors when the amount of time to perform a garbage collection operation exceeds the fixed amount of time. Additionally, there is also another need to reduce the amount of time used by garbage collection operations.

### SUMMARY

Various embodiments of the present invention provide methods and/or systems for performing block relinking during garbage collection. It should be appreciated that the embodiments can be implemented in numerous ways, including as a method, a circuit, a system, or a device. Several embodiments of the present invention are described below. In accordance with various embodiments of the present invention, block relinking is described. Block relinking may include writing a memory write to update a block of a first metablock to a block of a second metablock, copying valid portions of the block of the first metablock to the block of the second metablock, and linking the block of the second metablock to the first metablock.

Other embodiments and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified block diagram of an example of a non-volatile memory storage system, in accordance with an embodiment of the present invention;

FIG. 2 is a simplified block diagram of an organization of the memory cell array into planes;

FIG. 3 is a simplified block diagram of pages of memory cells;

FIG. 4 is a simplified block diagram of sectors of memory cells;

FIG. 5 is a simplified block diagram of a logical interface between a host and a non-volatile memory storage system;

FIG. 6 is a flowchart diagram of a general overview of operations for phased garbage collection, in accordance with an embodiment of the present invention;

FIG. 7 shows a simplified block diagram of one garbage collection operation split into multiple portions, in accordance with an embodiment of the invention;

FIGS. 8A-8B illustrate block relinking when updating an original metablock using an update metablock according to an embodiment;

FIG. 9 is a flowchart describing a process for relinking a metablock during garbage collection according to an embodiment;

FIGS. 10A-10C illustrate relinking of metablocks during garbage collection when one update metablock updates another update metablock;

FIG. 11A is a flowchart describing a process for relinking during garbage collection when a second update metablock is updating a first update metablock and the memory write in the second update metablock is written to a logical address of the first update metablock that includes written data;

FIG. 11B is a flowchart describing a process for relinking during garbage collection when a second update metablock is updating a first update metablock and the memory write in the second update metablock is written to a logical address of the first update metablock that is unwritten;

FIG. 12 is a flowchart describing a process for deciding which metablock to relink when multiple update metablocks are open according to an embodiment;

FIGS. 13A-13C illustrate compensation for offset changes in the blocks according to an embodiment;

FIG. 14 is flowchart describing a process for relinking including copying a memory write to a buffer according to an embodiment;

FIG. 15 is a flowchart describing a process for performing a first scenario of phased garbage collection including relinking while receiving a sequence of memory writes according to an embodiment;

FIG. 16 illustrates two logical groups (e.g., metablocks);

FIG. 17 is a flowchart describing a process for performing a second scenario of phased garbage collection including relinking while receiving a sequence of memory writes according an embodiment; and

FIG. 18 illustrates several metablocks that may be used to describe the process of the second scenario.

### DETAILED DESCRIPTION

A detailed description of one or more embodiments is provided below along with accompanying figures. The detailed description is provided in connection with such embodiments, but is not limited to any particular embodiment. The scope is limited only by the claims and numerous alternatives, modifications, and equivalents are encompassed. Numerous specific details are set forth in the following description in order to provide a thorough understanding. These details are provided for the purpose of example and the described embodiments may be implemented according to the claims without some or all of these specific details. For the purpose of clarity, technical material that is known in the technical fields related to the embodiments has not been described in detail to avoid unnecessarily obscuring the description.

The embodiments described herein provide methods and/or systems for performing partial garbage collection including block relinking. In general, during garbage collection, a memory update is performed. The memory update may be performed using an update metablock to update an original metablock. During garbage collection, valid portions (i.e., the portions not being updated) of a block of an original metablock are copied into a block of the update metablock. The block of the update metablock may then be disassociated from the remainder of the update metablock, and the block of the original metablock may be disassociated from the remainder of the original metablock. The block of the update metablock can then be linked to the remainder of the original metablock.

### A Non-volatile Memory Storage System

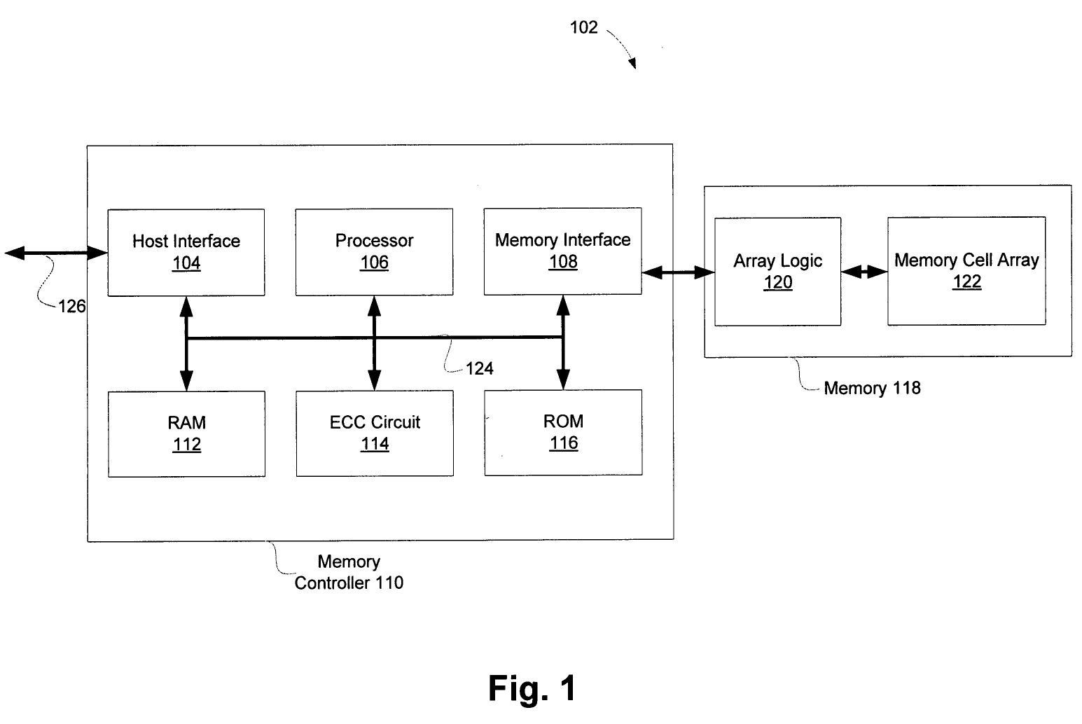

FIG. 1 is a simplified block diagram of an example of a non-volatile memory storage system, in accordance with an embodiment of the present invention. A host system (e.g., desktop computers, audio players, digital cameras, and other computing devices) may write data to and read data from non-volatile memory storage system 102. Non-volatile memory storage system 102 may be embedded within the host or removably connected to the host. As shown in FIG. 1, non-volatile memory storage system 102 includes memory controller 110 in communication with memory 118. In general, memory controller 110 controls the operation of memory 118. Examples of operations include writing (or programming) data, reading data, erasing data, verifying data, attending to garbage collection operations, and other operations. Memory controller 110 includes bus 124 that interfaces with system bus 126 through host interface 104 and the memory controller interfaces with memory 118 through memory interface 108. In communication with bus 124 include host interface 104, processor 106 (e.g., microprocessor, microcontrollers, and other processors), memory interface 108, random access memory (RAM) 112, error correcting code (ECC) circuit 114, and read-only memory (ROM) 116. ROM 116 can store a storage system firmware that includes program instructions for controlling the operation of memory 118. Processor 106 is configured to execute the program instructions loaded from ROM 116. The storage system firmware may be temporarily loaded into RAM 112 and additionally, the RAM may be used to buffer data that are transferred between a host and memory 118. ECC circuit 114 can check for error passing through memory controller 110 between the host and memory 118. If errors are found, ECC circuit 114 can correct a number of error bits, the number depending on the ECC algorithm utilized.

Memory 118 can include array logic 120 and non-volatile memory cell array 122. Non-volatile memory cell array 122 may include a variety of non-volatile memory structures and technologies. Examples of non-volatile memory technologies include flash memories (e.g., NAND, NOR, Multi-Level Cell (MLC), Divided bit-line NOR (DINOR), AND, high capacitive coupling ratio (HiCR), asymmetrical contactless transistor (ACT), other flash memories), erasable programmable read-only memory (EPROM), electrically-erasable programmable read-only memory (EEPROM), one-time programmable (OTP) memories, and other memory technologies.

Array logic 120 interfaces memory controller 110 with non-volatile memory cell array 122 and can provide, for example, addressing, data transfer and sensing, and other support to the non-volatile memory cell array and the memory cell array. To support non-volatile memory cell array 122, array logic 120 can include row decoders, column decoders, charge pumps, word line voltage generators, page buffers, input/output buffers, address buffers, and other circuitries.

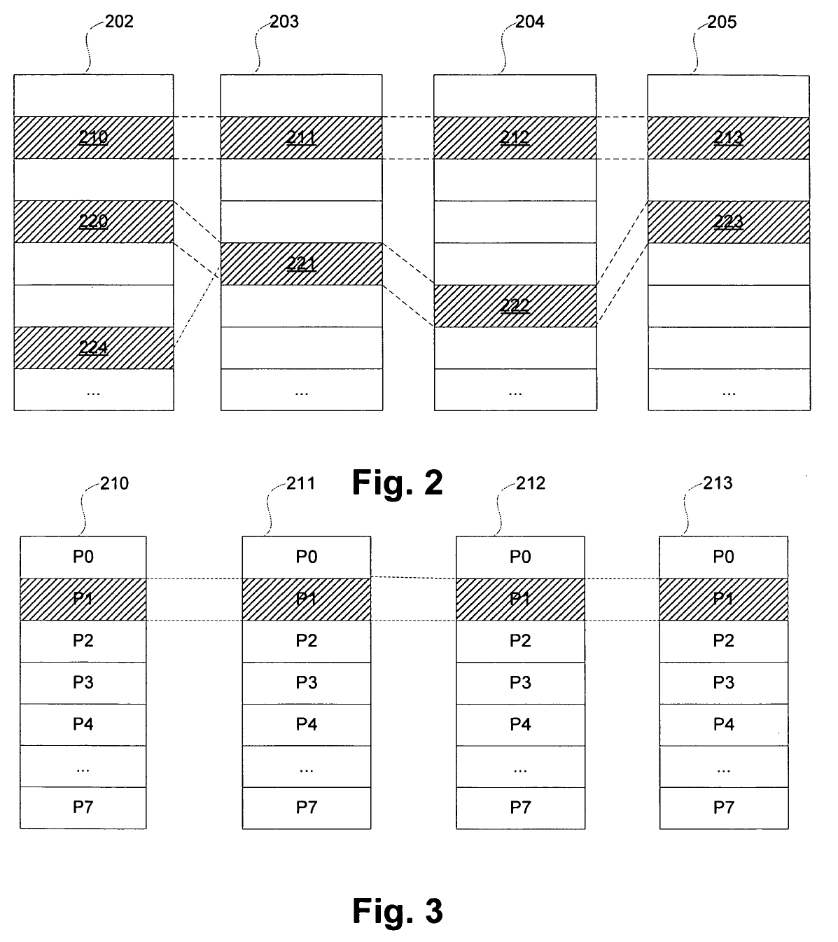

FIG. 2 is a simplified block diagram of an organization of the memory cell array into planes. One or more memory cell arrays may be divided into multiple planes or sub-arrays. In the example of FIG. 2, a memory cell array is divided into four planes 202-205. It should be appreciated that other number of planes, such as 1, 2, 8, 16, or more, can exist in a non-volatile memory storage system. Each plane 202, 203, 204, or 205 may be divided into blocks of memory cells, such as blocks 210-213 and 220-223, located in respective planes 202-205. A block of memory cells is the smallest number of memory cells that are physically erasable together. For increased parallelism, the blocks can be operated in larger metablock units where one block from each plane 202, 203, 204, or 205 is logically linked together to form a metablock. For example, four blocks 210-213 can be logically linked together to form a metablock. Further, the blocks used to form a metablock can be from various locations within their respective planes, such as planes 202-205. For example, four blocks 220-223 from various locations within their respective planes 202-205 can be logically linked together to form another metablock. A metablock may extend across all four logical planes 202-205 within the non-volatile memory storage system or the non-volatile memory storage system can dynamically form metablocks from one or more blocks in one or more different planes. Metablocks can be constructed from blocks in different planes on one or more dies and/or chips.

According to an embodiment, the logical linking between blocks (e.g., the blocks 220-223) to form a metablock may be stored in a data structure such as a block linking table. For example, the block linking table may indicate that the blocks 220, 221, 222, and 223 are linked together to form a metablock. As is discussed further below, blocks of a metablock may be disassociated and other blocks may be associated with a metablock. The block 220 may be disassociated from the metablock (i.e., removed), and a block 224 may subsequently be associated with the metablock. The block linking table could then describe a metablock including the blocks 224, 221, 222, and 223. This process may generally be referred to as “relinking.” According to an embodiment, increase reading and/or writing parallelism may be achieved by constructing metablocks from blocks located in different dies and/or chips.

FIG. 3 is a simplified block diagram of pages of memory cells. Each block, such as blocks 210-213, is further divided into pages of memory cells. As shown in FIG. 3, each block 210, 211, 212, or 213 is divided into eight pages P0-P7. Alternatively, there can be 16, 32, or more pages of memory cells within each block 210, 211, 212, or 213. To increase the operational parallelism of the non-volatile memory storage system, the pages within two or more blocks may be logically linked into metapages. For example, a metapage can be formed of one page, such as P1, from each of four blocks 210-213. A metapage can extend across all planes within the non-volatile memory storage system or the non-volatile memory storage system can dynamically form metapages from one or more pages in one or more separate blocks in one or more different planes.

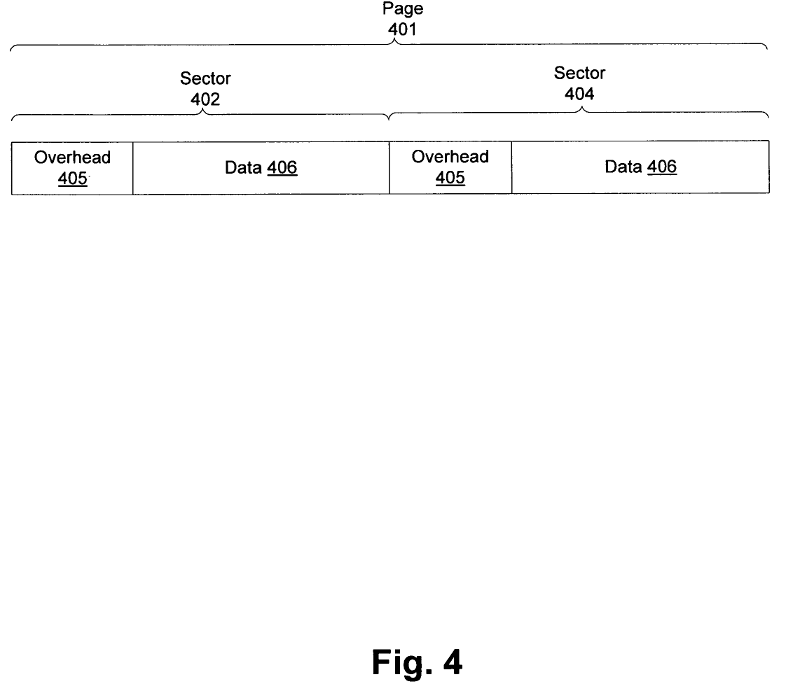

FIG. 4 is a simplified block diagram of sectors of memory cells. A page can be further divided into one or more sectors. The amount of data in each page can be an integer number of one or more sectors of data, where each sector may store 512 bytes of data. FIG. 4 shows page 401 divided into two sectors 402 and 404. Each sector 402 or 404 contains data 406, which can be 512 bytes in size, and overhead data 405 associated with the data. The size of overhead data 405 can be 16 bytes and can store, for example, an ECC calculated from data 406 during programming, the logical address associated with the data, a count of the number of times the block has been erased and re-programmed, control flags, operating voltage levels, and other information associated with the data.

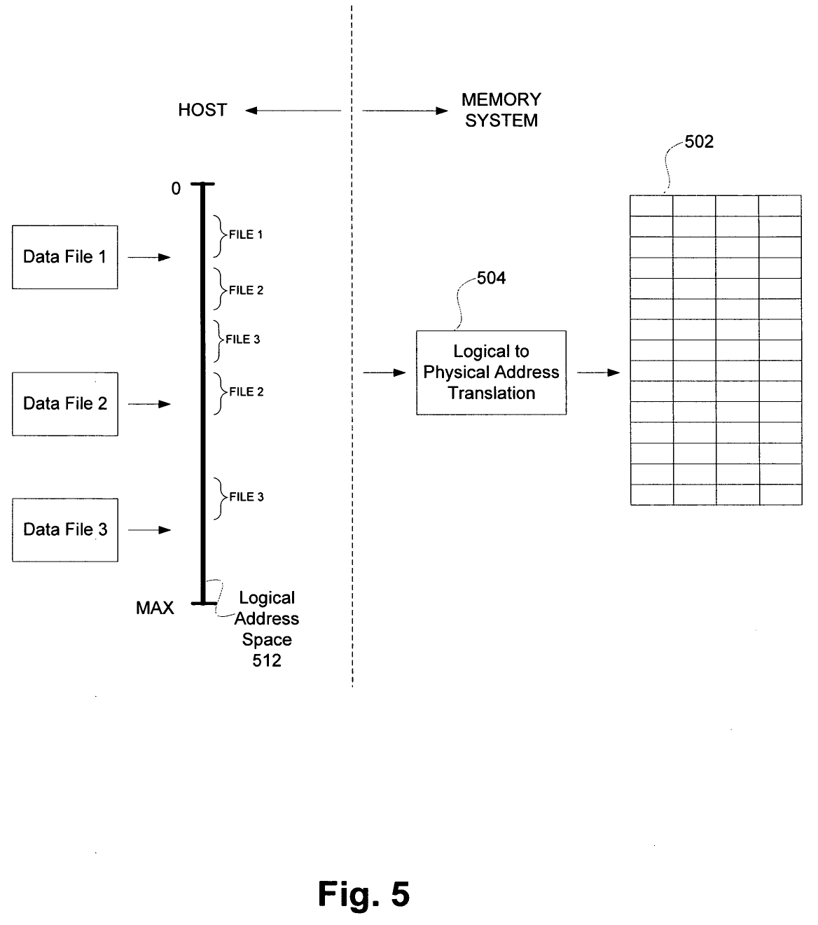

FIG. 5 is a simplified block diagram of a logical interface between a host and non-volatile memory storage system. A continuous logical address space 512 provides addresses for data that can be stored in memory. Logical address space 512 as viewed by the host can be divided into increments of clusters of data. Each cluster may include a number of sectors of data, such as between 4 and 64 sectors.

As shown in FIG. 5, an application program executed on the host creates three data files 1, 2, and 3. Files 1, 2, and 3 can be an ordered set of data and are identified by a unique name or other reference. The host assigns a logical address space to file 1 that is not already located to other files. Here, file 1 is shown to have been assigned a continuous range of available logical addresses.

When host creates file 2 after file 1, the host similarly assigns two different ranges of continuous addresses within logical address space 512. Host may not assign a continuous logical address to a file, such as file 1, 2, or 3, but can rather assign fragments of logical addresses in between logical address ranges already allocated to other files. The example of FIG. 5 shows that another file 3 is allocated other portions of logical address space 512 not previously allocated to files 1 and 2 and other data.

The host can keep track of logical address space 512 by maintaining a file allocation table (FAT), where the logical addresses assigned by the host to the various data files, such as files 1-3, by conversion are maintained. The host references files 1-3 by their logical addresses and not by the physical locations where the non-volatile memory storage system stores the files. On the other hand, the non-volatile memory storage system references files 1-3 by portions of the logical addresses to which data have been written and does not reference the files by the logical addresses allocated to the files. The non-volatile memory storage system converts the logical addresses provided by the host into unique physical addresses within memory cell array 502 where data from the host are stored. Block 504 represents a table of these logical-to-physical address conversions, which is maintained by the non-volatile memory storage system.

### Phased Garbage Collection

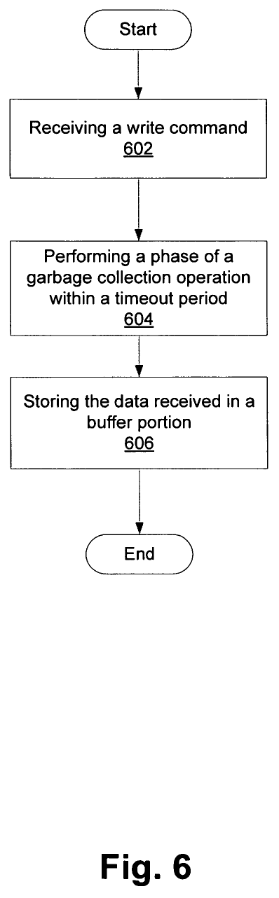

FIG. 6 is a flowchart diagram of a general overview of operations for phased garbage collection, in accordance with an embodiment of the present invention. Certain embodiments may perform relinking during phased garbage collection, as described here. It should be appreciated that data stored at specific host logical addresses can be overwritten by new data as the original stored data become obsolete. The non-volatile memory storage system, in response, writes the new data in an update metablock and then changes the logical-to-physical address table for those logical addresses to identify the new physical block to which the new data are stored. The blocks containing the original data at those logical addresses are then erased and made available for the storage of additional data (except when using an OTP or other write-once memory). Such erasure can take place before, during, or after a write operation. As a result, the memory controller learns that data at a given logical address has been rendered obsolete or invalid by the host after the new data are written to the same logical address. Many blocks of memory can therefore be storing invalid data for a period of time.

The sizes of blocks and metablocks are increasing and these increases result in a large proportion of individual data writes storing an amount of data that is less than the storage capacity of a metablock, and in many instances, even less than that of a block. Since the non-volatile memory storage system can direct new data to an erased pool metablock, such direction can result in portions of blocks or metablocks being unfilled. If the new data are updates of some data stored in another metablock, remaining valid metapages of data from that other metablock having logical addresses contiguous with those of the new data metapages are also copied in logical address order into the new metablock. The old metablock may retain other valid data metapages. Accordingly, data of certain metapages of an individual metablock can be rendered obsolete or invalid, and replaced by new data with the same logical address being written to a different metablock.

In order to maintain enough physical memory space to store data over a logical address space, such data can be periodically garbage collected (i.e., compacted or consolidated). In general, a garbage collection operation involves reading the valid data from a block and writing the valid data to a new block, ignoring invalid data in the process. The non-volatile memory storage system may perform the garbage collection operation within a timeout period allocated to a write command. If the garbage collection operation cannot be completed within one timeout period, then the one garbage collection operation may be split into several different phases (or portions), in accordance with an embodiment of the present invention. Here, the non-volatile memory storage system performs portions of the garbage collection operation using the timeout periods allocated to multiple write commands. In other words, the non-volatile memory storage system utilizes the timeout periods allocated to multiple write commands to perform portions of one garbage collection operation.

As shown in FIG. 6, a write command to write a memory write including new data is received in operation 602. As used herein, the term “new data” is defined as the data received by the non-volatile memory storage system from a write command to be written to the memory. The write command is allocated a timeout period to complete the execution of the write command. According to an embodiment, a multi-sector write command may have a timeout period allocated to each sector (or other data block). In other words, the timeout period is a period of time allocated for an execution of the write command. An example of a timeout period allocated is 250 milliseconds. The write command can be a single sector write command or a multiple sectors write command. In a single sector write command, new data can be written as single sectors to random addresses across a memory. When using a logical storage system with an LBA interface, for example, in a multiple sectors write command, multiple sectors of new data having contiguous local addresses are written to the memory.

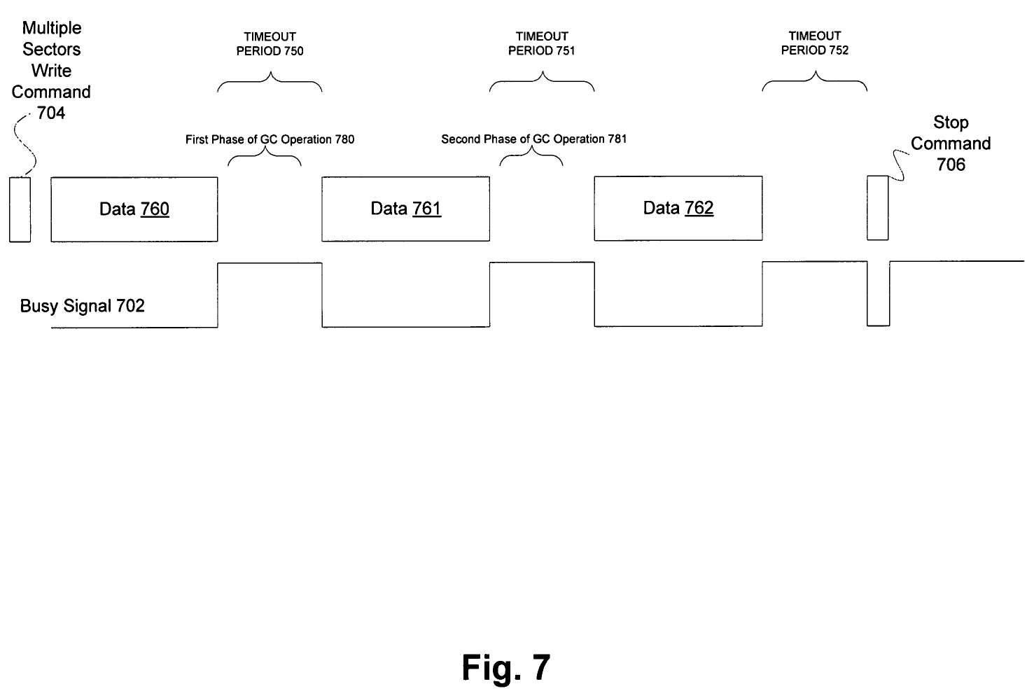

If one garbage collection operation cannot be completed within the timeout period, as shown in operation 604, a first phase of the garbage collection operation is performed within the timeout period allocated to the write command. The remaining phases of the garbage collection can be completed at later timeout periods. For example, FIG. 7 shows a simplified block diagram of an example of one garbage collection operation split into multiple phases 780 and 781, in accordance with an embodiment of the invention. As shown in FIG. 7, a non-volatile memory storage system receives multiple sectors write command 704 and subsequently, multiple sectors of new data 760-762 are received for storage into memory. Busy signal 702 is asserted after each sector of data 760, 761, or 762 is received to notify the memory host of the timeout period. The non-volatile memory storage system asserts busy signal 702 to allow the execution of the write command (e.g., a single sector or other unit of memory storage), which may include garbage collection operation (if needed), and other operations. A host does not send another command or additional data to the non-volatile memory storage system when busy signal 702 is asserted. The non-volatile memory storage system can assert busy signal 702 for a limited amount of time after each sector of data 760, 761, or 762 is received because the host allows a limited fixed amount of time (i.e., timeout periods 750-752) for the execution of the write command. If the busy signal remains active for longer than timeout period 750, 751, or 752, the host may repeat the write command or abort the process. Accordingly, the non-volatile memory storage system cannot assert busy signal 702 for more than timeout period 750, 751, or 752. Releasing busy signal 702 after the completion of writing multiple sectors of data 760-762 allows the host to communicate further with the non-volatile memory storage system.

Still referring to FIG. 7, phases 780 and 781 of the garbage collection can be allocated between multiple timeout periods 750-752. In other words, the non-volatile memory storage system can utilize each timeout period 750, 751, or 752 to perform each phase 780 or 781 of one garbage collection operation. For example, first phase 780 of one garbage collection is performed during first timeout period 750. Here, a portion of valid data can be copied from one block to another block during first timeout period 750. At second timeout period 751, the previous garbage collection operation started at first timeout period is continued. The non-volatile memory storage system performs second phase 781 of the previous garbage collection operation during timeout period 751 until the previous garbage collection is completed. The previous garbage collection can be completed by copying the remaining or last portion of the valid data from the one block to the other block. If the previous garbage collection operation cannot be completed within second timeout period 751, then the non-volatile memory storage system can use subsequent timeout periods, such as third timeout period 752, to complete the garbage collection operation. At the end of multiple sectors write command 704, the non-volatile memory storage system can assert busy signal 702 after stop command 706 is received or until all sectors of data 760-762 are written to the memory cell array.

Returning to FIG. 6, after a phase of the garbage collection operation is performed within a timeout period, the new data received from the write operation can be buffered in some memory storage (e.g., a separate buffer block, a scratchpad block) in operation 606.

### Relinking Metablocks

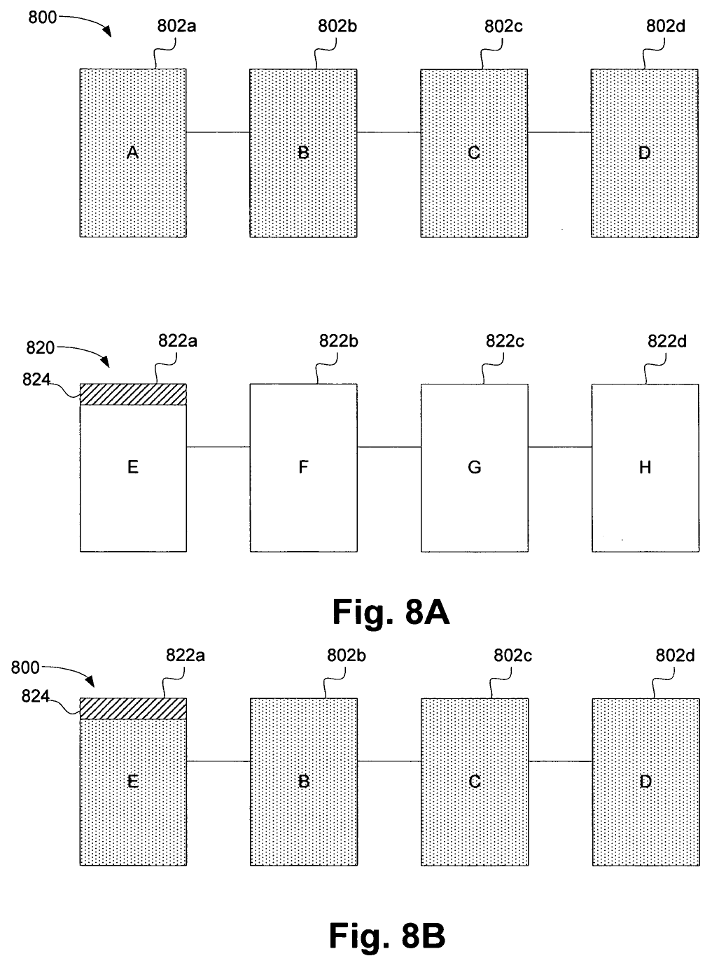

FIGS. 8A-8B illustrate block relinking when updating an original metablock using an update metablock according to an embodiment. FIG. 8A illustrates an original metablock 800, which includes stored data in several individual blocks 802a-802d, and an update metablock 820, which includes a memory write 824 that may include new data in a block 822a. An original metablock is a metablock that is storing data and is being updated. Portions of the original metablock may become invalid when new data received by the host is written to the update metablock. The update metablock 820 also includes the blocks 822b-822d, which, as shown here, are empty. An update metablock is allocated when a write command is received; the update metablock includes new data that may invalidate portions of the original metablock. It is understood that four blocks are shown in each metablock for convenience and clarity; a metablock may comprise any number of blocks as is appropriate for a specific application. According to an embodiment, data sectors may be striped across the blocks 822a-822d.

As described above, a metablock may be described using a block linking table. The block linking table may include an entry stating that the blocks 802a-802d comprise the original metablock 800, and that the blocks 822a-822d comprise the update metablock 820. When some blocks of the original metablock 800 and the update metablock 820 are relinked, the entry in the block linking table may be changed to reflect the relinking, according to an embodiment.

The update metablock 820 includes the memory write 824. The memory write 824 may be a memory write received from a write command that may be a single sector write. Alternatively, the block 822a may include a multiple sector write updating the original metablock 800. The memory write 824 updates a portion of the block 802a. During garbage collection, the valid portion of the block 802a (i.e., the portion that is not being updated by the memory write 824) is copied into the block 822a.

FIG. 8B illustrates the original metablock 800 that is a relinked metablock constructed from the unaltered blocks 802b-802d of the original metablock 800 and the garbage collected block 822a of the update metablock 820. The block 822a, as shown in FIG. 8B includes the memory write 824, as well as the valid portions of the block 802a. The block 802a is disassociated from the original metablock 800, and the block 822a is disassociated from the update metablock 820. The block 822a may be referred to as a “disassociated” block. A disassociated block may be a block that has been removed, or unlinked from a metablock. The garbage collected block 822a is then relinked with the remainder of the original metablock 800 (i.e., the blocks 802b, 802c, and 802d) to form the relinked original metablock 800.

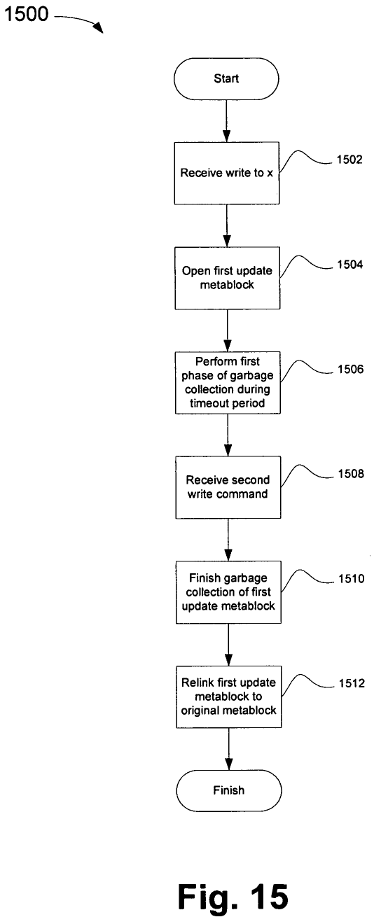

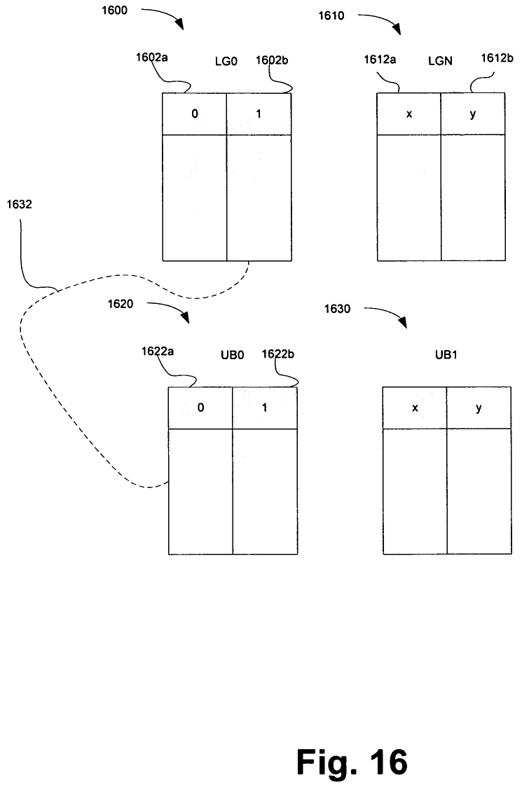

Several scenarios of phased garbage collection using block relinking are described regarding FIGS. 15-18. For example, block relinking may be used in conjunction with phased garbage collection to reduce the time needed to transfer data from an original metablock to an update metablock. It is understood, however, that block relinking may be used independent of garbage collection operations.

When performing garbage collection, the worst case scenario (i.e., the longest time it may take to complete a garbage collection) may be given by equation (1):

T_{gc}=T_{prog}*N_{pages/block}+T_{xfer}*N_{pages/block}*Nₚₐᵣₐₗₗₑₗᵢₛₘ+Tₑᵣₐₛₑ (1)

where T_{gc} is the time to garbage collect, T_{prog} is the time to program a page, T_{xfer} is the time to transfer a page of data, N_{pages/block} is the number of pages in a block (e.g., 32), Nₚₐᵣₐₗₗₑₗᵢₛₘ is the number of physical blocks programmed and erased in parallel (e.g., the number of blocks in a metablock), and Tₑᵣₐₛₑ is the time to erase.

Using the process described regarding FIGS. 8A and 8B, the original metablock 800 may be updated without copying the blocks 802b-802d that are not being updated. In this way, the worst case scenario time of garbage collection for the update of the original metablock 800 is now:

T_{gc}=T_{prog}*N_{pages/block}+T_{xfer}*N_{pages/block}+Tᵣₑₗᵢₙₖ+Tₑᵣₐₛₑ (2)

where Tᵣₑₗᵢₙₖ is the time to relink a metablock. As can be seen, the Nₚₐᵣₐₗₗₑₗᵢₛₘ factor is not present in the equation (2). According to an embodiment, the relinking time Tᵣₑₗᵢₙₖ may include block erase time and control update time.

If the garbage collection is completed in less than a single timeout period (e.g., less than 250 ms), the garbage collection may be performed without being phased. Alternatively, the garbage collection may be split into two or more phases, as described with respect to FIGS. 6 and 7, and this process may be used to allow lengthier garbage collection without encountering a timeout error.

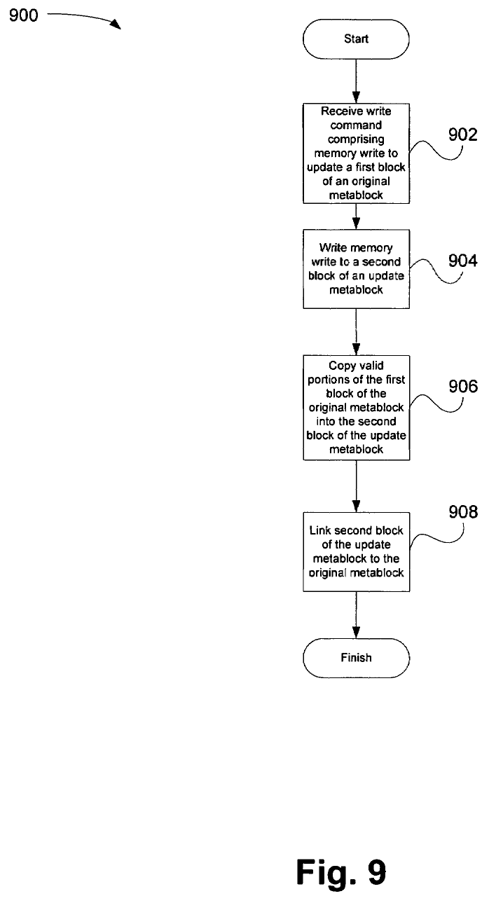

FIG. 9 is a flowchart describing a process for relinking a metablock during garbage collection according to an embodiment. The process 900 generally describes receiving a write command to update an original metablock, writing a memory write of the write command to an update metablock, and performing garbage collection of the update metablock and the original metablock including relinking a block of the update. According to an embodiment, garbage collection may be triggered by another memory write command to another original metablock.

The process 900 describes a general process for performing relinking while copying data that may comprise a portion of a garbage collection operation. According to various embodiments, garbage collection may be performed as part of a sequence of memory writes. FIGS. 15 and 16 include flowcharts describing various scenarios for multi-phased garbage collection that occur during sequences of memory writes.

In operation 902, a write command comprising a memory write to update a first block (e.g., the block 802a) of an original metablock (e.g., the original metablock 800) is received. The memory write may be, for example, a single- or multi-sector write.

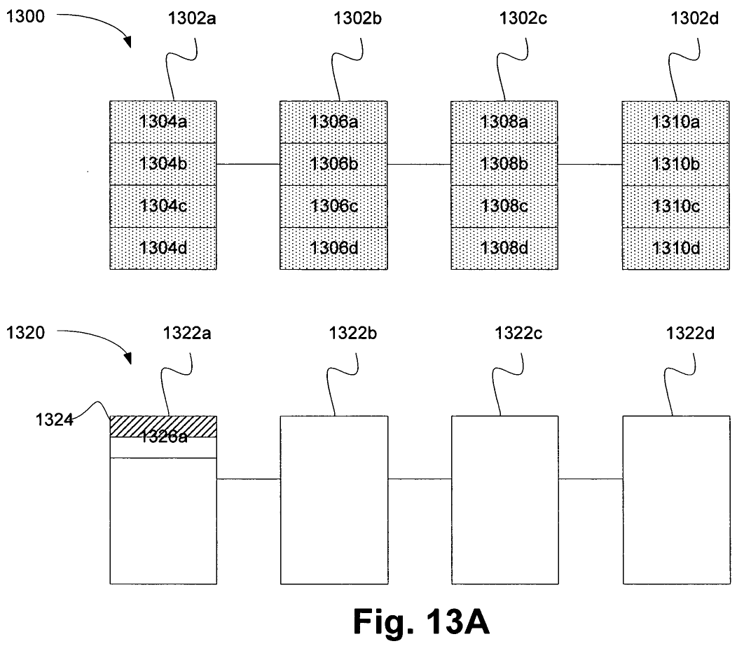

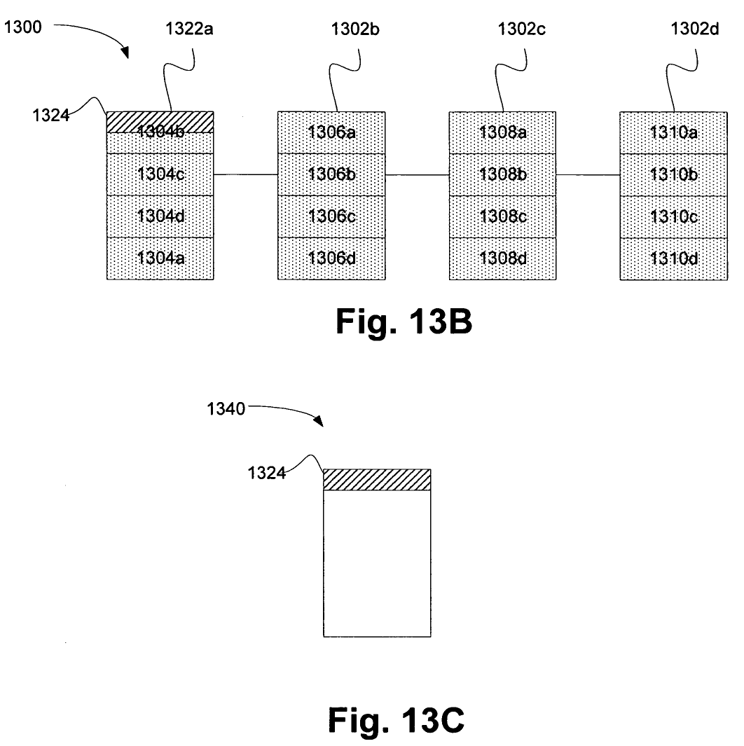

In operation 904, the memory write is written to a second block of the update metablock. For example, the block 822a (e.g., the second block) of the update metablock 820 may correspond to the block 802a of the original metablock 800. The memory write is written to the second block of the update metablock that corresponds to the first block of the original metablock so that the memory write updates the appropriate portion of the original metablock (e.g., the memory write is written to the block 822a to update the block 802a). As is discussed further regarding FIGS. 13A-C and 14, the memory write may first be written to a buffer such as a scratch pad block, according to certain embodiments. The memory write may then be written to the second block during the copying described in operation 906.

In operation 906, valid portions of the first block of the original metablock are copied to the second block of the update metablock. According to an embodiment, the operation 906 may be triggered by a new write to another logical group, which may result in the closing of the update metablock 820. This operation may comprise a portion of garbage collection. For example, as shown above in FIG. 8B, the block 822a includes the memory write 824, plus the valid portions of the block 802a of the original metablock 800. The operation 906 may include copying and consolidating these data into the second block of the update metablock to generate a second block including the updated valid data. As is described below regarding FIGS. 13A-C and 14, the operation may include copying new data of the memory write to a buffer, and copying new data of the memory write along with the valid portions of the first block of the original metablock into the second block of the update metablock in a logical order.

In operation 908, the second block of the update metablock is linked to the original metablock. According to an embodiment, linking the second block of the update metablock to the original metablock may include several operations. First, the first block is disassociated (i.e., unlinked) from the original metablock (e.g., the block 802a). Next, the second block of the update metablock is disassociated from the update metablock (e.g., the block 822a). Finally, the second block of the update metablock is linked to the remainder of the original metablock (e.g., blocks 802b-802d), forming a relinked original metablock (e.g., see FIG. 8B).

The resulting original metablock is a garbage collected metablock updated with the data of the memory write (e.g., the memory write 824). For example, the relinked original metablock 800 shown in FIG. 8B includes the block 822a and the memory write 824 from the update metablock 820. The relinked original metablock 800 also includes the unaltered blocks 802b-802d. As demonstrated using equation (2), by relinking metablocks during garbage collection, the amount of time to garbage collect the update metablock 820 may be reduced. Further, relinking of metablocks may be combined with phased garbage collection to avoid timeout errors.

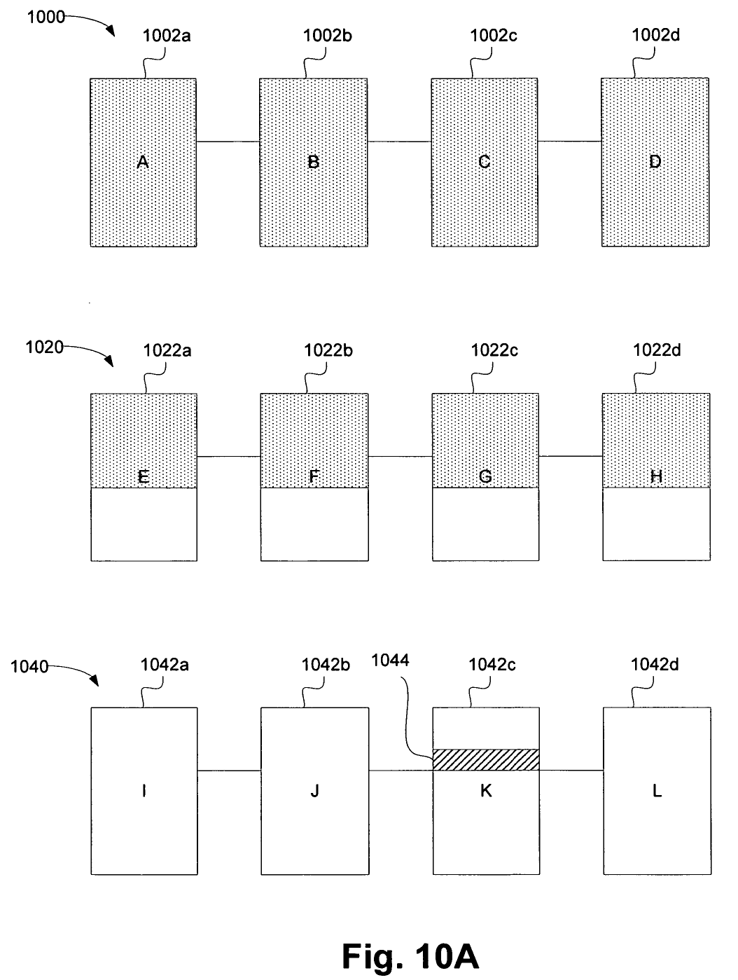

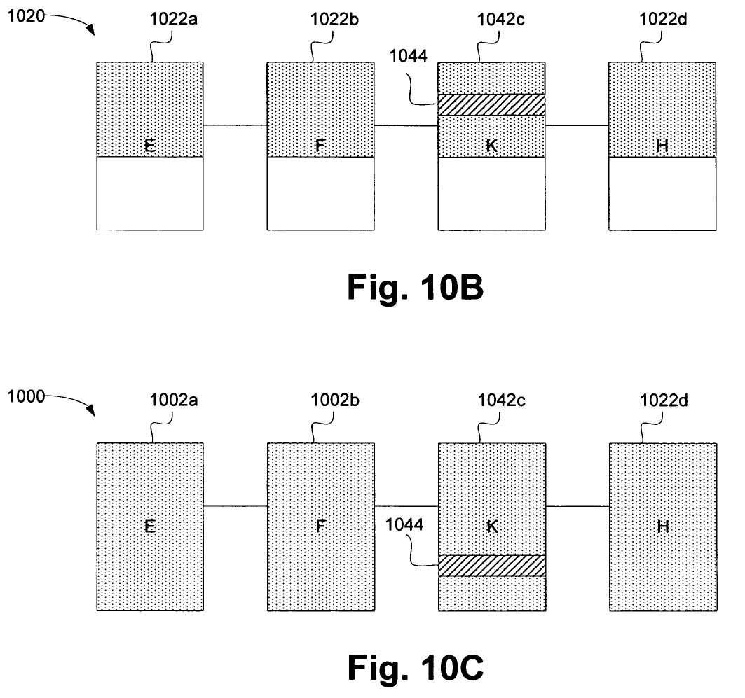

FIGS. 10A-10C illustrate relinking of metablocks during garbage collection when a host write command updates a logical group with an already open update metablock. FIG. 10A illustrates an original metablock 1000 and two update metablocks 1020 and 1040. The original metablock 1000 is being updated by the update metablock 1020. The update metablock 1040 is in turn updating the update metablock 1020. The update metablock 1020 may include update data (e.g., a memory write) for one or more blocks of the original metablock 1000. The update metablock 1040 includes update data for a block of the update metablock 1020 according to an embodiment.

According to an embodiment, the update metablock 1040 may be a temporary entity allocated for the garbage collection operation. Once the relinking is complete, the update metablock 1040 may be returned to the pool of update metablocks. The update metablock 1020 may remain open as long as it is not full and no other writes invoke its closure.

The original metablock 1000 includes four blocks 1002a-1002d. The update metablock 1020 includes four blocks 1022a-1022d. Each of the four blocks 1022a-1022d of the update metablock 1020 includes update data for each of the four blocks 1002a-1002d of the original metablock 1000. The update metablock 1040 includes a memory write 1044 in a block 1042c, as well as empty blocks 1042a, 1042b, and 1042d. The memory write 1044 is to update the block 1022c of the update metablock 1020.

Similar to the scenario described regarding FIGS. 8A, 8B, and 9, when the update metablock 1040 is garbage collected, only the block 1042c is garbage collected. The other blocks 1042a, 1042b, and 1042d are empty, and the block 1042c is relinked into the update metablock 1020, while the other blocks 1042a, 1042b, and 1042d can be discarded and reallocated.

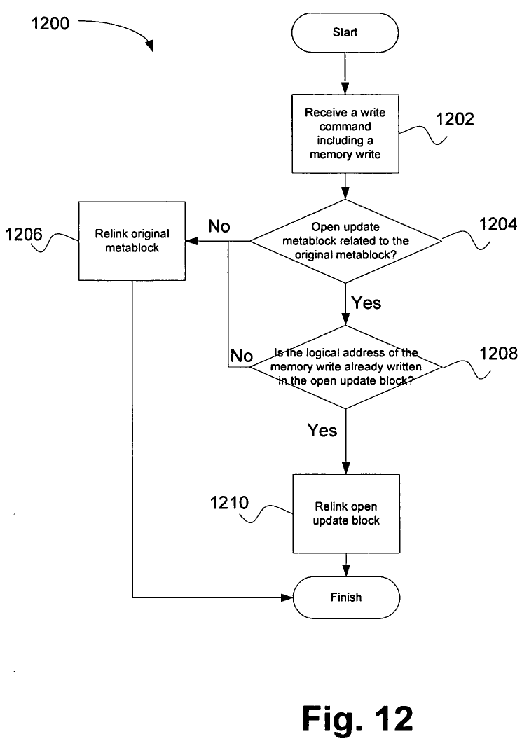

According to different scenarios, the block 1042c may either be garbage collected with the block 1022c of the update metablock 1020 or with the block 1002c of the original metablock 1000. FIG. 12 describes a process for determining which block to garbage collect. Both scenarios are described herein; FIG. 10B shows a garbage collected update metablock 1020, and FIG. 10C shows a garbage collected original metablock 1000. Generally, the update metablock 1020 is garbage collected with the update metablock 1040 if the memory write 1044 updates a logical address already written to the update metablock 1020. Otherwise, the original metablock 1000 is garbage collected with the update metablock 1040, and the original metablock 1000 is subsequently garbage collected with the update metablock 1020. Regardless of which block is garbage collected first, the resulting update metablock 1020 is then garbage collected with the original metablock 1000 to consolidate the valid data of the update metablock 1020 and the original metablock 1000.

FIG. 10B illustrates the garbage collected metablock 1020 according to an embodiment. First, the block 1042c, including the memory write 1044, is garbage collected by copying the valid portions of the block 1022c into the block 1042c. The block 1022c, which is updated by the update metablock 1040, is disassociated from the update metablock 1020. The block 1042c is then linked to the metablock 1020. The relationship between the blocks 1022a, 1022b, 1042c, and 1022d (i.e., that they form the metablock 1020) may be noted in a block-linking table as described above. After the linking, the block 1042c effectively replaces the block 1022c in the update metablock 1020.

After the block 1042c is linked into the update metablock 1020, the update metablock 1020 may be used to update the original metablock 1000. The updating of the original metablock 1000 may be performed using any type of garbage collection, including phased garbage collection, and may further include another instance of metablock relinking.

FIG. 10C illustrates an alternative scenario in which the second update metablock 1040 may be garbage collected with the original metablock 1000 according to an embodiment. In certain situations, for example if the logical address of the memory write 1044 is not yet written to the block 1022c (i.e., the update metablock 1040 is updating a portion of the update metablock 1020 that is not yet written), the update metablock 1040 may be garbage collected with the original metablock 1000 before the update metablock 1020 updates the original metablock 1000. For example, FIG. 10C shows that the block 1042c has been garbage collected with the block 1002c, and the block 1042c has been relinked into the original metablock 1000. The update metablock 1020 is unchanged; the update metablock 1020 may then be garbage collected with the relinked original metablock 1000. According to another embodiment, as is described regarding FIGS. 15 and 16, the update metablock 1020 may or may not be garbage collected with the metablock 1000. As described above, the update metablock 1020 may be consolidated with the original metablock 1000 using any appropriate garbage collection technique including phased garbage collection and relinking as described herein.

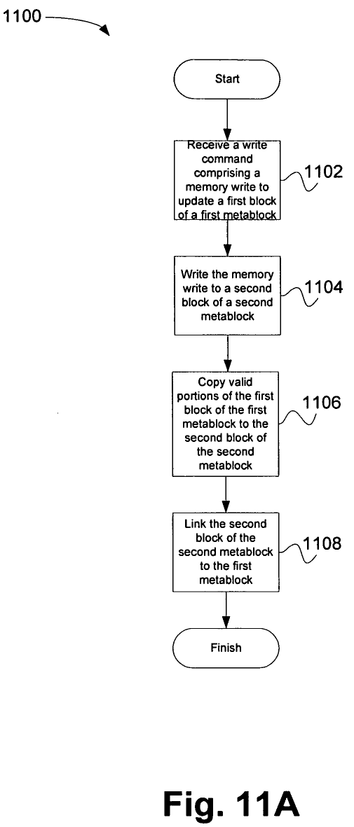

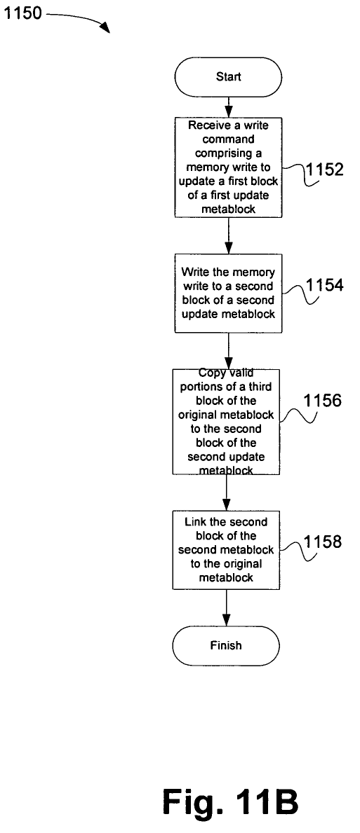

FIG. 11A is a flowchart describing a process 1100 for relinking during garbage collection when a second update metablock is updating a first update metablock and the memory write in the second update metablock is written to a logical address of the first update metablock that includes written data. The process 1100 generally describes the scenario shown in FIG. 10B.

In operation 1102, a write command comprising a memory write to update a first block of a first metablock is received. The memory write may be, as described above, a single- or multi-sector memory write. The first metablock may be a first update metablock (e.g., the update metablock 1020) that is being updating by a second update metablock (e.g., the update metablock 1040). For example, the first block may be the block 1022c of the update metablock 1020 that is being updated.

In operation 1104, the memory write is written to a second block of a second metablock. The second metablock may be a second update metablock (e.g., the update metablock 1040) updating the first update metablock. The second block may be, for example, the block 1042c of the update metablock 1040. According to an embodiment, the first block and the second block may be allocated from the same memory plane (see, e.g., FIG. 2). According to an embodiment, the memory write may be written to a buffer (e.g., a scratch pad block), and may be written to the second block during garbage collection (e.g., during the operation 1106). According to another embodiment, the memory write may be written to some other memory location, such as any location in a RAM or other memory.

In operation 1106, valid portions of the first block of the first metablock are copied to the second block of the second metablock. Operation 1106 may include portions of garbage collection as described above.

In operation 1108, the second block of the second metablock is linked to the first metablock. Operation 1108 may include relinking, as described above. For example, the first block may be disassociated from the first metablock. Then, the second block may be disassociated from the second metablock. Finally, the second block may be associated with the first metablock. The linking of the metablocks may be described in a block-linking table, for example. After the relinking, the first metablock may be as the update metablock 1020 as shown in FIG. 10B.

FIG. 11B is a flowchart describing a process 1150 for relinking during garbage collection when a second update metablock is updating a first update metablock and the memory write in the second update metablock is written to a logical address of the first update metablock that is unwritten. The process 1150 generally describes the scenario shown in FIG. 10C.

In operation 1152, a write command comprising a memory write to update a first block of a first update metablock is received. The first update metablock (e.g., the update metablock 1020) may be updating an original metablock (e.g., the original metablock 1000). The memory write may be, as described above, a single- or multi-sector memory write. For example, the first block may be the block 1022c of the update metablock 1020 that is being updated.

In operation 1154, the memory write is written to a second block of a second update metablock. The second update metablock may be the update metablock 1040, for example. The second block may be, for example, the block 1042c of the update metablock 1040. According to an embodiment, the first block and the second block may be allocated from the same memory plane (see, e.g., FIG. 2). According to an embodiment, the memory write may be written to a buffer (e.g., a scratch pad block or other memory), and may be written to the second block during garbage collection (e.g., during the operation 1156).

In operation 1156, valid portions of a third block of the original metablock are copied to the second block of the second metablock. Operation 1106 may include portions of garbage collection as described above. The third block of the original metablock may be, for example, the block 1002c. According to an embodiment, the third block and the second block may be consolidated when it is determined that the memory write is written to a logical address of the first update metablock that is unwritten. In other words, the third block and the second block are consolidated when the memory write updates a portion of the first update metablock that contains no data.

In operation 1158, the second block of the second metablock is linked to the original metablock. Operation 1158 may include relinking, as described above. For example, the third block may be disassociated from the original metablock. Then, the second block may be disassociated from the second metablock. Finally, the second block may be associated with the original metablock. The linking of the metablocks may be described in a block-linking table, for example. After the relinking, the original metablock may be as the original metablock 1000 as shown in FIG. 10C. Also after the relinking, the first update metablock may update the original metablock.

FIG. 12 is a flowchart describing a process 1200 for deciding which metablock to relink when multiple update metablocks are open according to an embodiment. For example, the process 1200 may be used to decide whether to relink a garbage collected block into an original metablock, or into another update metablock. The process 1200 may be used in situations, for example, where a memory write to update a logical group that already has an open update metablock (e.g., the scenarios shown in FIG. 10A). Additionally, the process 1200 may be used where there is no open update metablock (see, e.g., operation 1204).

In operation 1202, a write command including a memory write is received. The memory write may be, for example, a single or multi-sector write such as the memory write 1044. The memory write is written into an available update metablock. Alternatively, the memory write may be written to another logical group without an open update metablock.

In operation 1204, it is determined whether there is another open update metablock (e.g., the update metablock 1020) related to the original metablock (e.g., the original metablock 800 or 1000). If there is not another open update metablock, in operation 1206, it is determined that the original metablock (e.g., the original metablock 800) is to be relinked (see, e.g., FIG. 8B). When the original metablock 800 is relinked, for example, the block 822a of the update metablock 820 replaces the block 802a of the original metablock 800, as shown in FIG. 8B.

If there is another open update metablock, as determined in operation 1204, the process 1200 continues to operation 1208, where it is determined whether the logical address of the memory write is already written in the other open update metablock. If the logical address of the memory write is already written to the open update metablock, in operation 1210, the open update metablock is relinked. For example, as shown in FIG. 10B, the memory write 1044 updates a logical address that already exists in the block 1020c. The block 1020c of the update metablock 1020 is to be relinked in this case.

If the memory write writes to a logical address that is not already in the other open update metablock, in operation 1206, the original metablock is relinked. For example, as shown in FIG. 10C, the memory write 1044 writes to a logical address not occupied by the data of the block 1022c of the update metablock 1020. In this case, the block 1042c is garbage collected and relinked with the original metablock 1000.

### Reliking While Retaining Offsets of Blocks

FIGS. 13A-13C illustrate compensation for offset changes in the blocks according to an embodiment. When a metablock is read, the individual blocks of the metablock may be read in parallel. For example, a metablock 1300 includes four individual blocks 1302a-1302d. Each of the blocks 1302a, 1302b, 1302c, and 1302d includes several pages 1304, 1306, 1308, and 1310, respectively. When the metablock 1300 is read, the blocks 1302 may be read in parallel; for example, the pages 1304a, 1306a, 1308a, and 1310a may be read concurrently. Then, the pages 1304b, 1306b, 1308b, and 1310b would be read.

When a block is garbage collected, the process of garbage collection may change the order of the pages within the block. For example, during a garbage collection operation, an update metablock 1320 may include a block 1322a to update the block 1302a. The update metablock may include a memory write 1324 (e.g., a single- or multi-sector write) to update the page 1304b. The update metablock includes the memory write 1324 written to a first page 1326a of the block 1322a.

FIG. 13B illustrates a change in offset after relinking according to an embodiment. After garbage collection is completed and the block 1322a is relinked with the metablock 1300, the addresses of the written pages 1304 within the block 1322a changes. For example, the first page 1304a includes data that would have been written to the second page 1304b. When reading the metablock 1300, the memory system compensates for this discrepancy, known as “offset,” using a page tag. The page tag indicates the amount of offset. In this example, the page tag is now different for the different blocks 1322a, 1302b, 1302c, and 1304d of the metablock 1300.

Uniform page tags may be retained throughout the metablock 1300 by buffering the memory write 1324 to a temporary location such as a buffer (e.g., somewhere in RAM) or scratch pad block. FIG. 13C illustrates writing a memory write to a buffer before garbage collection. A scratch pad block 1340 is a temporary storage block into which any memory data may be temporarily stored. The memory write 1324 may be written to the scratch pad block 1340, and the update metablock 1320 is then empty before garbage collection.

The scratch pad block 1340 may be used by the non-volatile memory system as temporary storage according to various embodiments. Specifically, new data (e.g., a memory write) can be temporarily stored in the scratch pad block 1340, before being transferred to the update metablock during consolidation, in accordance with an embodiment of the present invention. It should be appreciated that a scratch pad block 1340 is a form of data update block in which logical sectors within an associated logical group may be updated in a random order and with any amount of repetition. The scratch pad block 1340 is created by a write command where the intended logical sectors do not end at or cross physical page boundary. The scratch pad block 1340 can contain partial physical pages worth of data but no partial programmed page data are allowed. The scratch pad block 1340 can hold a valid page of data for each update metablock in the non-volatile memory storage system. The non-volatile memory storage system can have, for example, eight update metablocks allocated and therefore, the scratch pad block can store, with the addition of the temporary storage functionality, nine valid pages of data.

During garbage collection, the valid portions of the block 1302a and the memory write 1324 may be combined together into the block 1322a. Because the memory write 1324 is written from the scratch pad block 1340, the proper offset and page tag may be retained during garbage collection. According to an embodiment, a write to one logical group may trigger garbage collection of another logical group. An update metablock for the write not be available at the time the write is made. According to another embodiment, the write may either be written into the update block, where the page tag may be changed, or may be buffered (e.g., into the scratch pad block 1340) and given any page tag later. The garbage collection for the other logical group may be performed in a phased manner (e.g., two phases of garbage collection), or may be performed using relinking.

For example, if the memory write 1324 has a logical address in the page 1304b, the page 1304a is first written to the block 1322a. Then the memory write 1324 and other valid data of the page 1304b are written to the block 1322a, and the page 1304c and any subsequent pages are written to the block 1322a. The write may be completed in sequential logical address order. The block 1322a can then be relinked to the original metablock 1300 using techniques described above. Additionally, these techniques may eliminate the need for a separate page offset for each physical block (e.g., as in FIG. 13B).

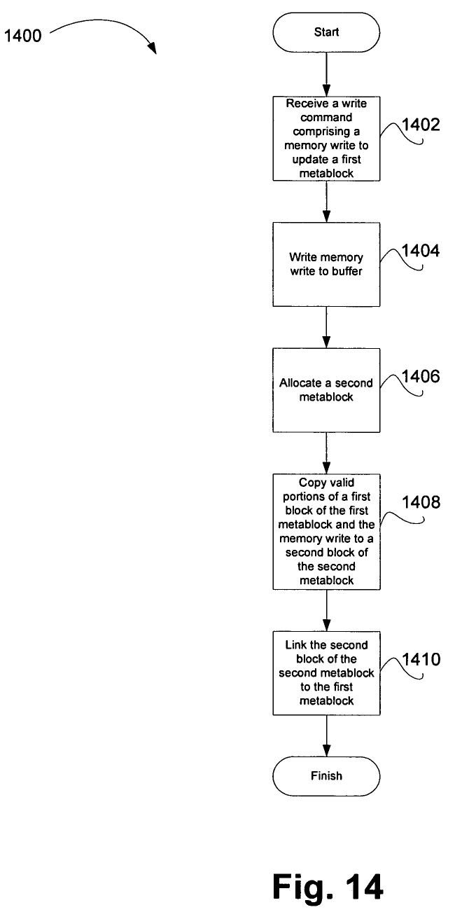

FIG. 14 is flowchart describing a process for relinking including copying a memory write to a buffer according to an embodiment. The process 1400 generally describes garbage collection including relinking blocks including copying a memory write to a buffer and copying valid portions of an original metablock and the memory write in a logical address order.

In operation 1402, a write command comprising a memory write to update a first metablock is received. As described above, the memory write may be a single- or multi-sector memory write including update data. The first metablock may be an original metablock or an update metablock according to various embodiments.

In operation 1404, the memory write is written to a buffer. The buffer may be a scratch pad block (e.g., the scratch pad block 1340) or other temporary data storage. As previously described, if an update metablock is available, the memory write may also be written directly to the update metablock, and the page tag of the memory write may be changed at that time. In operation 1406, a second metablock is allocated. The second metablock may be, for example, an update metablock.

In operation 1408, valid portions of a first block of the first metablock and the memory write are copied to a second block of the second metablock. The valid portions and the memory write may be copied in a logical order corresponding to the first metablock. For example, pages of the first block may have an offset or page tag, and the copying retains this offset or page tag. The resulting second block has the same offset as the first block.

In operation 1410, the second block of the second metablock is linked to the first metablock. As described above, the linking may include disassociating the second block from the second metablock, disassociating the first block from the first metablock, and associating the second block with the first metablock.

### Phased Garbage Collection Using Relinking While Receiving a Sequence of Writes

FIGS. 15-18 describe processes for performing phased garbage collection using block relinking. More specifically, these figures describe various scenarios during which a sequence of write commands (e.g., multiple single- or multi-sector writes) are received. FIGS. 15-16 and FIGS. 17-18 each describe a scenario in which block relinking may be used in association with phased garbage collection (as described in FIGS. 7 and 8).

FIG. 15 is a flowchart describing a process 1500 for performing a first scenario of phased garbage collection including relinking while receiving a sequence of memory writes according to an embodiment. FIG. 16 illustrates a first scenario of phased garbage collection including block relinking according to an embodiment. The process 1500 generally describes two memory writes. The first memory write is written to a first metablock, and the second memory write is subsequently written to a second metablock. The second memory write may trigger garbage collection of an update metablock to which the first memory write is written.

FIG. 16 illustrates two logical groups (e.g., metablocks) 1600 and 1610. Each of the logical groups 1600 and 1610 is a metablock comprising two blocks 1602 and 1612, respectively. In operation 1502, a write is received to an address x in the block 1602a of the metablock 1600. The address x may be any address within the block 1602a. When the write is received, a first update metablock 1620 is opened in operation 1504. The update metablock 1620 may be used to update the metablock 1600.

The first update metablock 1620 may be written to in two phases. For example, the write to the address x may be a single sector write to which a timeout period is assigned. In operation 1506, a first phase of garbage collection may be performed during a timeout period. The first phase of garbage collection may include copying valid data (i.e., data from the block 1602a that is not from the addresses to which the write is written, plus the write) to the block 1622a of the first update metablock 1620.

In operation 1508, a second write command is received. The second write command may be written to the block 1612a of the metablock 1610. The second write command opens a second update metablock 1630. In some scenarios, there may not be an additional available update metablock, so the first update metablock 1620 should be closed (i.e., the first update should be completed) before the second update metablock 1630 can be allocated. However, there may not be sufficient time before the expiration of the timeout period to finish writing the first update metablock 1620. Relinking can be used to close the first update metablock 1620 before the timeout period expires.

In operation 1510, the remainder of the garbage collection of the block 1622a of the first update metablock 1620 is completed. The garbage collection may include copying the valid data from the memory write (e.g., the written sector) and the block 1602a into the block 1622a. In block 1512, the block 1622a (i.e., the first update metablock) is linked to the block 1602b (i.e., the original metablock), to create a new metablock. The new metablock is the updated metablock including the memory write. Since the new metablock has been updated, the process 1500 may close the first update metablock 1620 and open the second update metablock 1630.

The relinking between the blocks 1602b and 1622a is shown by the connection 1632. Additionally, page tags may be maintained during the process 1500 as discussed above regarding FIGS. 13-14.

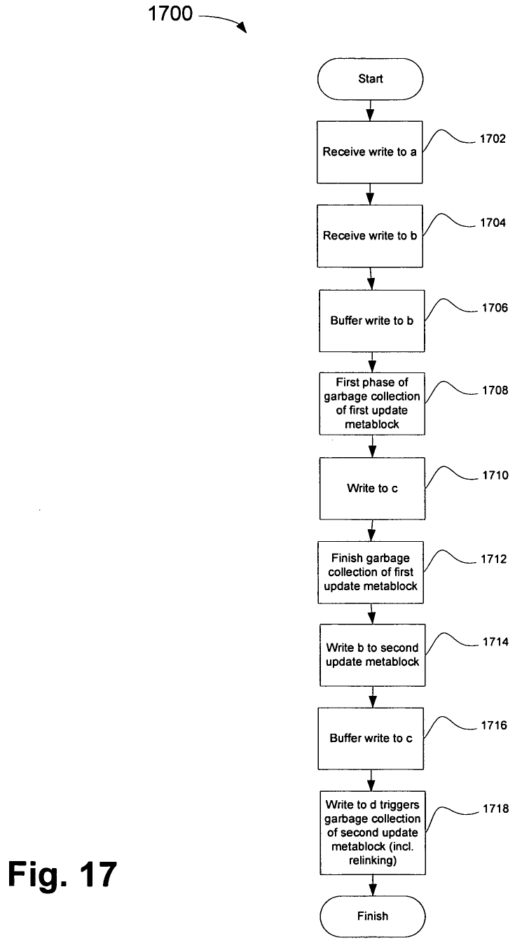

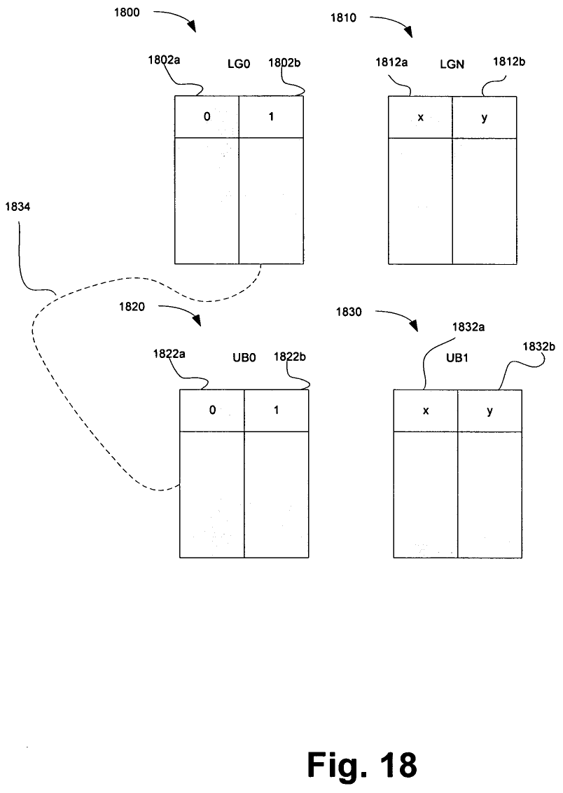

FIG. 17 is a flowchart describing a process 1700 for performing a second scenario of phased garbage collection including relinking while receiving a sequence of memory writes according an embodiment. The process 1700 describes a series of four writes, some of which may trigger garbage collection. FIG. 18 illustrates several metablocks that may be used to describe the process 1700 of the second scenario.

In operation 1702, a write to an address a in a block 1802a of a metablock 1800 is received. The address a and the other addresses described herein are arbitrary and may represent any address within the block they are located in. The metablock 1800 may comprise two blocks 1802a and 1802b. The write may also result in a first update metablock 1820 including two blocks 1822a and 1822b being opened. In operation 1704, a write to an address b in a block 1812a of a metablock 1810 is received. The metablock 1810 may comprise two blocks 1812a and 1812b. The write to the address b may trigger garbage collection of the update metablock 1820 (corresponding to the write to the address a) according to an embodiment.

In operation 1706, the write to the address b is buffered to a scratch pad block (or to any other location within the memory storage system). The written sector may be buffered to allow the sector to be written at a later time, after other consolidation has been completed. After the sector has been buffered, in operation 1708, garbage collection of the first update metablock 1820 begins. According to an embodiment, a portion (e.g., half) of the garbage collection of the update metablock 1820 may be completed during the first busy period.

In operation 1710, a write to an address c is received. As a result of receiving the write to the address c, the remainder of the garbage collection of the update metablock 1820 is completed in operation 1712, the sector buffered to the scratch pad block in operation 1706 (i.e., the write to b) is written to a second update metablock 1830 in operation 1714, and the sector written to the address c is written to the scratch pad block (or other storage) in operation 1716.

In operation 1718, a write to an address d is received. The write to the address d may trigger garbage collection of the second update metablock 1830. This garbage collection may be a phased garbage collection including relinking. For example, the garbage collection may be completed during one or more busy periods. During garbage collection, data may only be written to a block 1832a of the metablock 1830. The block 1832a may then be relinked to the block 1812b of the metablock 1810.

The relinking between the blocks 1802b and 1822a is shown by the connection 1834. Additionally, page tags may be maintained during the process 1700 as discussed above regarding FIGS. 13-14.

Although the foregoing embodiments have been described in some detail for purposes of clarity of understanding, the embodiments are not limited to the details provided. There are many alternative ways of the implementing the embodiments. Accordingly, the disclosed embodiments are to be considered as illustrative and not restrictive, and the embodiments are not to be limited to the details given herein, but may be modified within the scope of equivalents of the appended claims. In the claims, elements and/or operations do not imply any particular order of operation, unless explicitly stated in the claims.

What is claimed is:

1. A method comprising:
writing a memory write to update a block of a first metablock to a block of a second metablock;
copying valid portions of the block of the first metablock to the block of the second metablock; and
linking the block of the second metablock to the first metablock.

2. The method of claim 1, wherein linking the block of the second metablock to the first metablock comprises:
disassociating the block of the first metablock from the first metablock;
disassociating the block of the second metablock from the second metablock to produce a disassociated block; and
associating the disassociated block with the first metablock.

3. The method of claim 1, wherein copying the valid portions comprises performing phased garbage collection.

4. The method of claim 1, wherein linking the block of the second metablock comprises updating a block-linking table.

5. The method of claim 1, wherein writing the memory write to the block of the second metablock comprises writing the memory write to the block of a first update metablock.

6. The method of claim 5, further comprising receiving a write command comprising a memory write to update a second update metablock.

7. The method of claim 1, further comprising allocating the block of the first metablock and the block of the second metablock from a same memory plane.

8. The method of claim 1, wherein writing the memory write to the block of the second metablock comprises writing the memory write to a buffer and copying the memory write to the block of the second metablock in a logical address order with the valid portions during the copying the valid portions from the block of the first metablock.

9. The method of claim 8, wherein the writing the memory write to the buffer comprises writing the memory write to one of a scratch pad block and a random access memory (RAM).

10. The method of claim 1, further comprising receiving a write command comprising a single-sector memory write.

11. A method comprising:
receiving a write command comprising a memory write to update a block of a first update metablock, the first update metablock to update an original metablock;
writing the memory write to a block of a second update metablock;
copying valid portions of a block of the original metablock to the block of the second update metablock; and
linking the block of the second update metablock to the original metablock.

12. The method of claim 11, further comprising updating the original metablock using the first update metablock after the linking.

13. The method of claim 11, further comprising allocating the block of the first update metablock and the block of the second update metablock from a same memory plane.

14. The method of claim 11, further comprising determining that the memory write is written to a logical address of the first update metablock that is unwritten in the first update metablock.

15. The method of claim 11, wherein linking the block of the second update metablock to the original metablock comprises:
disassociating the block of the second update metablock from the second update metablock to produce a disassociated block;
disassociating the block of the original metablock from the original metablock;
and
associating the disassociated block with the original metablock.

16. The method of claim 11, wherein writing the memory write to the block of the second update metablock comprises writing the memory write to a buffer and copying the memory write to the block of the second update metablock in an order with the valid portions of the block of the original block during a garbage collection operation.

17. The method of claim 16, wherein the writing the memory write to the buffer comprises writing the memory write to a scratch pad block.

18. The method of claim 11, wherein the copying retains a page tag of the block of the first metablock.

19. A method comprising:
receiving a write command comprising a memory write to update a first metablock;
writing the memory write to a buffer;
allocating a second metablock;
copying valid portions of a block of the first metablock and the memory write to a block of the second metablock in a logical order corresponding to the first metablock; and
linking the block of the second metablock to the first metablock.

20. The method of claim 19, wherein writing the memory write to the buffer triggers garbage collection in another logical group.

21. The method of claim 19, wherein copying valid portions may be performed during subsequent host writes.

22. The method of claim 19, wherein receiving the write command comprising the memory write to update the first metablock comprises receiving the write command comprising a memory write to update an original metablock.

23. The method of claim 19, wherein allocating the second metablock comprises allocating a first update metablock.

24. The method of claim 23, wherein receiving the write command comprising a memory write to update the first metablock comprises receiving a write command comprising a memory write to update a second update metablock.

25. The method of claim 19, wherein writing the memory write to the buffer comprises writing the memory write to a scratch pad block.

26. The method of claim 19, wherein copying the valid portions and the memory write in the logical order comprise retaining an offset of the second metablock during the copying.

27. The method of claim 19, wherein linking the block of the second metablock to the first metablock comprises:
disassociating the block of the first metablock from the first metablock;
disassociating the block of the second metablock from the second metablock to produce a disassociated metablock; and
associating the disassociated block with the first metablock.

28. The method of claim 20, further comprising choosing to perform the garbage collection of the another group using phased garbage collection or using relinking.
